(19) United States
(12) Patent Application Publication
(10) Pub. No.: US 2021/0005983 A1
(43) Pub. Date: Jan. 7, 2021

(54) ARRAY ANTENNA DEVICE

(71) Applicant: Mitsubishi Electric Corporation, Tokyo (JP)

(72) Inventors: Satoshi YAMAGUCHI, Tokyo (JP); Hikaru WATANABE, Tokyo (JP); Toru FUKASAWA, Tokyo (JP)

(73) Assignee: Mitsubishi Electric Corporation, Tokyo (JP)

(21) Appl. No.: 17/040,798

(22) PCT Filed: May 14, 2018
(86) PCT No.: PCT/JP2018/018585

§ 371 Date: Sep. 23, 2020

(51) Int. Cl. H01Q 21/24; H01Q 21/06

(52) U.S. Cl. CPC H01Q 21/24; H01Q 21/061

(57) ABSTRACT

In adjacent two of linear array antennas, respective first element antennas and respective second element antennas are arranged so that positions of the first element antennas in the arrangement direction are shifted from each other by a half an arrangement interval and positions of the second element antennas in the arrangement direction are shifted from each other by a half the arrangement interval, the arrangement interval being an interval between the element antennas. In two of the linear array antennas, the first element antennas of one of the two and the second element antennas of the other one of the two are arranged at the same positions, and the second element antennas of the one of the two and the first element antennas of the other one of the two are arranged at the same positions, the two being located two linear array antennas away from each other.

### TECHNICAL FIELD

The present invention relates to an array antenna device used in radars or wireless communication.

### BACKGROUND ART

In the design of array antenna devices, it is necessary not to generate grating lobes that are unwanted radiation other than the main lobe. Whether or not a grating lobe occurs depends on the arrangement of element antennas included in an array antenna device. In order to prevent generation of grating lobes, it is only required to arrange element antennas at intervals of less than or equal to a predetermined distance with respect to the wavelength of the operating frequency. However, there are cases where it is difficult to arrange element antennas at narrow intervals due to physical factors such as the size of the element antennas.

Meanwhile, for example, Patent Literature 1 discloses a method that can reduce occurrence of grating lobes even in a case where it is difficult to arrange element antennas at narrow intervals. In this method, in a slotted waveguide array antenna device, multiple slotted waveguide array antennas are arranged on a plane, slotted waveguide array antennas adjacent to each other in a direction perpendicular to the tube axis of a rectangular waveguide are grouped, and groups of slotted waveguide array antennas, the groups being adjacent to each other in a direction of the tube axis, are arranged in a mutually zigzag shape in an offsetting manner by a distance of substantially a half of a free space wavelength of the operating frequency in the direction perpendicular to the tube axis. With this arrangement, phases of radio waves radiated in the direction perpendicular to the tube axis of the waveguide by adjacent groups of slotted waveguide array antennas become reverse phases, and as a result, grating lobes can be canceled.

### CITATION LIST

### Patent Literature

Patent Literature 1: JP 2007-259047 A

### SUMMARY OF INVENTION

### Technical Problem

In the conventional array antenna device described in Patent Literature 1, the case where the number of polarization types of the antennas is only one is considered. Meanwhile, in recent years, polarization division multiplexing technology has been used to increase the amount of information transmitted and received in communication applications. This technology is to double the amount of transmitted information by transmitting and receiving information without interfering nor being interfered with each other, for example, by giving different information to each of two waves having respective polarization planes perpendicular to each other. However, in the conventional array antenna device as described in Patent Literature 1, no consideration is made for the polarization division multiplexing, and there is no clear method for arranging array antennas having distinct polarization types in the same antenna aperture.

The present invention has been made to solve the problem as described above, and an object of the invention is to provide an array antenna device capable of suppressing grating lobes even in a case where the array antenna device has two polarization types.

### Solution to Problem

An array antenna device according to the present invention includes: linear array antennas in each of which a first element antenna and a second element antenna are alternately arranged linearly, the first and second element antennas having respective polarization planes perpendicular to each other, in which the linear array antennas are arranged in a direction perpendicular to an arrangement direction of the first and second element antennas, in adjacent two of the linear array antennas, respective first element antennas each of which is the first element antenna and respective second element antennas each of which is the second element antenna are arranged so that positions of the respective first element antennas in the arrangement direction are shifted from each other by a half an arrangement interval and positions of the respective second element antennas in the arrangement direction are shifted from each other by a half the arrangement interval, the arrangement interval being an interval between the first element antenna and the second element antenna, and in two of the linear array antennas, the first element antenna of one of the two and the second element antenna of the other one of the two are arranged at the same position, and the second element antenna of the one of the two and the first element antenna of the other one of the two are arranged at the same position, the two being located two linear array antennas away from each other.

### Advantageous Effects of Invention

In an array antenna device of the present invention, in adjacent two linear array antennas, first element antennas and second element antennas are arranged so that positions of the first element antennas in the arrangement direction are shifted from each other by a half an arrangement interval between the element antennas and positions of the second element antennas in the arrangement direction are shifted from each other by a half the arrangement interval. In addition, in two linear array antennas, first element antennas of one of the two and second element antennas of the other one of the two are arranged at the same positions, and second element antennas of the one of the two and first element antennas of the other one of the two are arranged at the same positions, the two being located two linear array antennas away from each other. As a result, grating lobes can be suppressed even in an array antenna device having two polarization types.

### BRIEF DESCRIPTION OF DRAWINGS

FIG. 1 is a configuration diagram illustrating an array antenna device according to a first embodiment of the invention.

FIG. 2 is a configuration diagram illustrating an array antenna device of a comparative example.

FIG. 3 is an explanatory graph illustrating relative radiation patterns of the array antenna device of the first embodiment of the present invention and the comparative example.

FIG. 4 is a configuration diagram illustrating an array antenna device according to a second embodiment of the invention.

FIG. 5 is a configuration diagram illustrating an array antenna device according to a third embodiment of the invention.

FIG. 6 is a configuration diagram illustrating another example of the array antenna device according to the third embodiment of the invention.

### DESCRIPTION OF EMBODIMENTS

To describe the present invention further in detail, embodiments for carrying out the present invention will be described below with reference to the accompanying drawings.

### First Embodiment

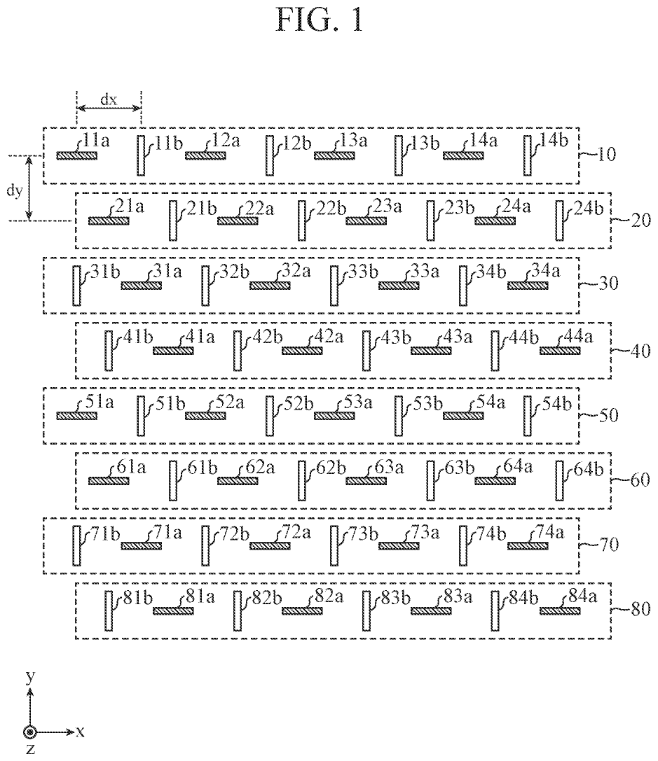

FIG. 1 is a configuration diagram of an array antenna device according to the present embodiment.

The array antenna device illustrated in FIG. 1 includes a linear array antenna 10 including first element antennas 11a to 14a and second element antennas 11b to 14b, a linear array antenna 20 including first element antennas 21a to 24a and second element antennas 21b to 24b, a linear array antenna 30 including first element antennas 31a to 34a and second element antennas 31b to 34b, a linear array antenna 40 including first element antennas 41a to 44a and second element antennas 41b to 44b, a linear array antenna 50 including first element antennas 51a to 54a and second element antennas 51b to 54b, a linear array antenna 60 including first element antennas 61a to 64a and second element antennas 61b to 64b, a linear array antenna 70 including first element antennas 71a to 74a and second element antennas 71b to 74b, and a linear array antenna 80 including first element antennas 81a to 84a and second element antennas 81b to 84b.

Here, the first element antennas 11a to 84a and the second element antennas 11b to 84b are element antennas included in an array antenna. Each of the first element antennas 11a to 84a and the second element antennas 11b to 84b schematically represents an element antenna such as a dipole antenna, and has polarization of the longitudinal direction of the rectangle. That is to say, the first element antennas 11a to 84a and the second element antennas 11b to 84b are perpendicular to each other. In the following, a component assigned with symbol a is distinguished as a first element antenna, and a component assigned with symbol b is distinguished as a second element antenna. In addition, a two-digit number assigned with the symbol represents the position of the element in the arrangement. For example, the first element antenna 31a represents the first element antenna located in the third row and the first column.

For example in the linear array antenna 10, the first element antenna 11a and the second element antenna 11b, the first element antenna 12a and the second element antenna 12b, the first element antenna 13a and the second element antenna 13b, and the first element antenna 14a and the second element antenna 14b are arranged linearly and alternately at element intervals dx in the x-axis direction in the drawing. The element interval dx may be constant within the linear array antenna, or may differ for each element interval. Other linear array antennas 20 to 80 are similarly configured.

These linear array antennas 10 to 80 are arranged in multiple rows at element intervals dy in a direction perpendicular to the arrangement direction of the first element antennas 11a to 84a and the second element antennas 11b to 84b, that is, in the y-axis direction in the drawing. These linear array antennas 10 to 80 form an array antenna. The element interval dy may be constant between the linear array antennas or may differ for each linear array antenna.

In adjacent two of the linear array antennas 10 to 80, the first element antennas 11a to 84a and the second element antennas 11b to 84b are arranged so that the positions of the first element antennas 11a to 84a in the arrangement direction are shifted from each other by a half an arrangement interval of the first element antennas 11a to 84a and the second element antennas 11b to 84b, that is, by dx/2, and so that the positions of the second element antennas 11b to 84b in the arrangement direction are shifted from each other by a half the arrangement interval, that is, by dx/2. For example, as illustrated in FIG. 1, the position of the first element antenna 11a of the linear array antenna 10 and the position of the first element antenna 21a of the linear array antenna 20 are shifted from each other by dx/2.

Furthermore, in two of the linear array antennas 10 to 80 located two linear array antennas away from each other, namely for example in the linear array antenna 10 and the linear array antenna 30, the positions of the first element antennas 11a to 14a of the linear array antenna 10 in the arrangement direction (positions in the x direction) and the positions of the second element antennas 31b to 34b of the linear array antenna 30 in the arrangement direction are the same, and the positions of the second element antennas 11b to 14b of the linear array antenna 10 in the arrangement direction (positions in the x direction) and the positions of the first element antennas 31a to 34a of the linear array antenna 30 in the arrangement direction are the same. The positional relationship between the first element antennas 11a to 84a and the second element antennas 11b to 84b in other linear array antennas 10 to 80 is also similar.

Note that although four of the first element antennas 11a to 84a and four of the second element antennas 11b to 84b are included as element antennas in each of the linear array antennas 10 to 80 in the illustrated example, the number of element antennas included in a linear array antenna is not limited thereto. Likewise, although eight linear array antennas 10 to 80 are included, the number of linear array antennas may be another number.

Next, the operation of the array antenna device of the first embodiment will be described.

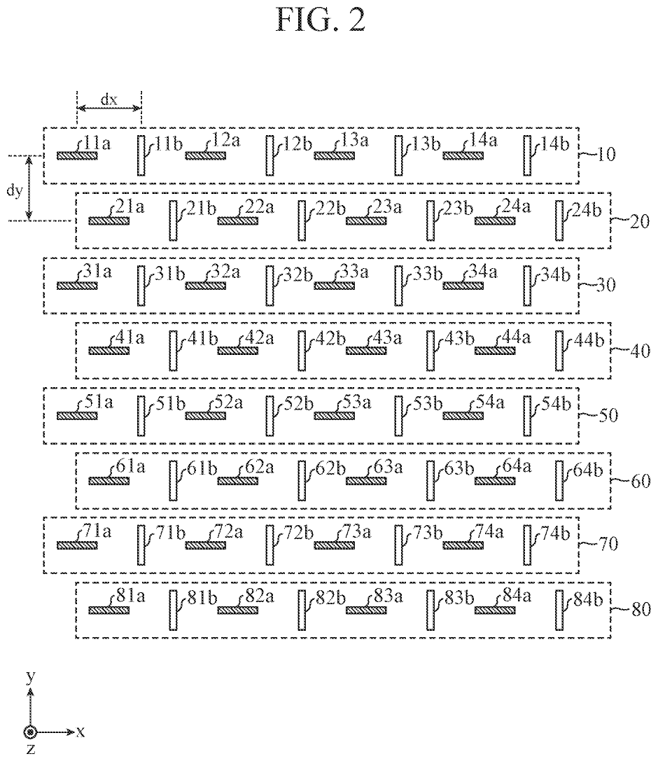

As a comparative example, FIG. 2 illustrates a configuration in which, in each of linear array antennas 10 to 80, first element antennas 11a to 84a and second element antennas 11b to 84b have the same arrangement.

In FIG. 2, when focusing on only the first element antennas or only the second element antennas with regard to the element antennas arranged in the x direction, the element intervals are unequal. For example, the x-direction distance between the first element antenna 11a and the first element antenna 21a is dx/2, whereas the distance between the first element antenna 21a and the first element antenna 32a is dx×3/2. That is to say, the element antennas are arranged with omissions in the x direction. In such an arrangement, there are cases where wavefronts are aligned in a direction other than the direction in which the main lobe is generated, and thereby unwanted lobes such as grating lobes or large side lobes equivalent thereto may be generated. On the other hand, when focusing on the element antennas arranged in the x direction in FIG. 1, since all the element antennas are arranged at equal intervals of dx/2, it is possible to suppress generation of unwanted lobes.

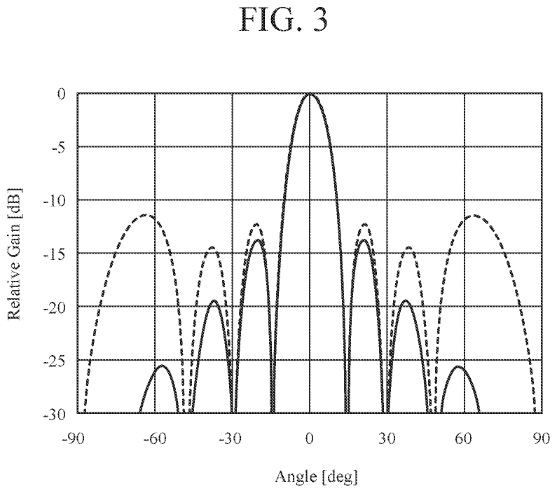

In FIG. 3, relative radiation patterns of the array antenna device of the first embodiment and the comparative example of FIG. 2 are illustrated. Here, the vertical axis represents the relative gain, and the horizontal axis represents the angle (deg.) in a half space of the xz plane. A solid line illustrates the characteristics of the array antenna device of the first embodiment, and a broken line illustrates the characteristics of the array antenna device of the comparative example. In FIG. 3, calculation results of the radiation pattern of the array antenna device of the first embodiment illustrated in FIG. 1 and the radiation pattern of the array antenna device of the comparative example illustrated in FIG. 2 are illustrated assuming that the directivity of each element is a cosine electric field directivity (cos θ). The element intervals dx and dy are set to half the wavelength of the calculation frequency. As is clear from FIG. 3, the array antenna device according to the first embodiment can sufficiently suppress grating lobes appearing in wide angle directions.

Regarding the feeding of the first element antennas 11a to 84a and the second element antennas 11b to 84b, a circuit for supplying a high-frequency signal may be included in each of the element antennas. Alternatively, the multiple first element antennas 11a to 84a and the multiple second element antennas 11b to 84b may be grouped as sub-arrays, and a circuit for supplying a high-frequency signal may be included in each of the sub-arrays.

As described above, the array antenna device of the first embodiment includes linear array antennas in each of which a first element antenna and a second element antenna alternately arranged linearly, the first and second element antennas having respective polarization planes perpendicular to each other. The linear array antennas are arranged in a direction perpendicular to the arrangement direction of the element antennas. In adjacent two of the linear array antennas, respective first element antennas and respective second element antennas are arranged so that positions of the first element antennas in the arrangement direction are shifted from each other by a half an arrangement interval and positions of the second element antennas in the arrangement direction are shifted from each other by a half the arrangement interval, the arrangement interval being an interval between the first element antenna and the second element antenna. In two of the linear array antennas, the first element antenna of one of the two and the second element antenna of the other one of the two are arranged at the same position, and the second element antenna of the one of the two and the first element antenna of the other one of the two are arranged at the same position, the two being located two linear array antennas away from each other. Therefore, grating lobes can be suppressed even in an array antenna device having two polarization types.

Moreover, according to the array antenna device of the first embodiment, the arrangement intervals of the first element antenna and the second element antenna in each of the linear array antennas are equal, and thus generation of unwanted lobes can be suppressed.

Moreover, according to the array antenna device of the first embodiment, the arrangement intervals of the linear array antennas are equal, and thus generation of unwanted lobes can be suppressed.

According to the array antenna device of the first embodiment, the polarization of the first element antennas is one of vertical polarization and horizontal polarization, and the polarization of the second element antennas is the other one of vertical polarization and horizontal polarization, and thus it is possible to implement an array antenna device having two perpendicular polarization types.

### Second Embodiment

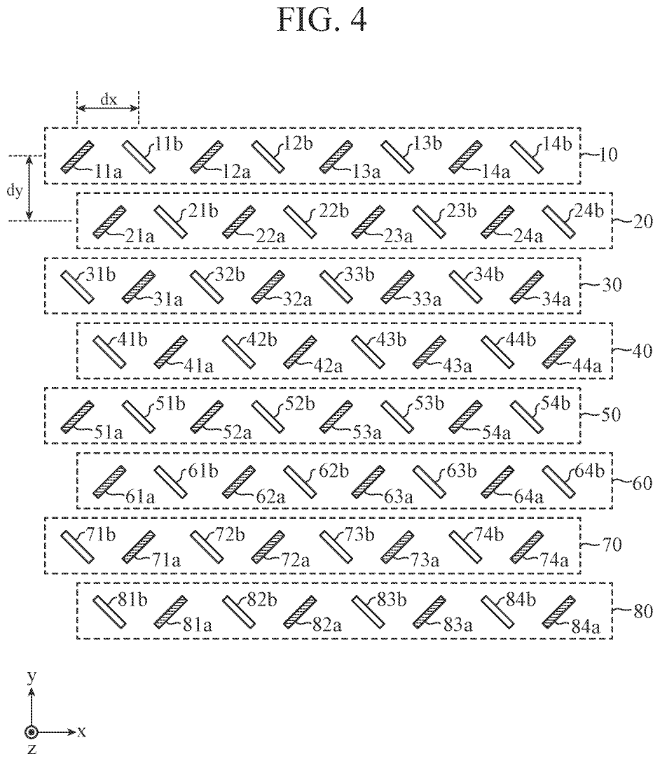

FIG. 4 is a configuration diagram of an array antenna device of a second embodiment.

In the first embodiment, the polarization of the first element antennas 11a to 84a is the x-direction polarization, and the polarization of the second element antennas 11b to 84b is the y-direction polarization; however in the second embodiment, either the first element antennas 11a to 84a or the second element antennas 11b to 84b have polarization of +45 degrees, and the other element antennas have polarization of −45 degrees. In the array antenna device illustrated in FIG. 4, an example is illustrated in which first element antennas 11a to 84a have polarization of +45 degrees and second element antennas 11b to 84b have polarization of −45 degrees. The arrangement of the first element antennas 11a to 84a and the second element antennas 11b to 84b in linear array antennas 10 to 80 is similar to that of the first embodiment. Furthermore, the combination of polarization of the first element antennas 11a to 84a and polarization of the second element antennas 11b to 84b is not limited to the illustrated example, and a similar combination may be used as long as polarization of the first element antennas 11a to 84a and polarization of the second element antennas 11b to 84b are perpendicular to each other.

As described above, according to the array antenna device of the second embodiment, the polarization of the first element antennas is either one of polarization of +45 degrees and polarization of −45 degrees, and the polarization of the second element antennas is the other one of the two. Thus, grating lobes can be suppressed even in an array antenna device having two polarization types.

### Third Embodiment

In a third embodiment, each of the first element antennas 11a to 84a and the second element antenna 11b to 84b includes multiple elements.

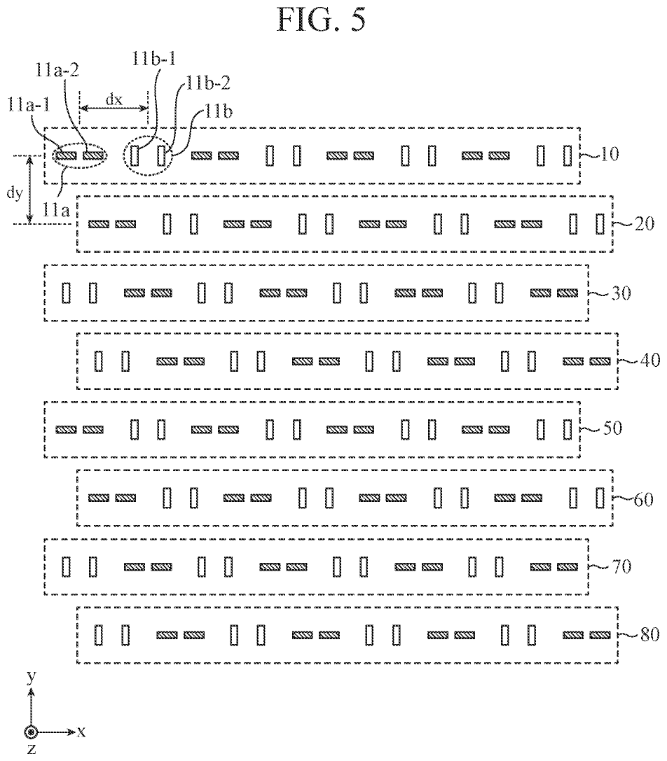

FIG. 5 is a configuration diagram of an array antenna device of the third embodiment. In the illustrated array antenna device, a first element antenna 11a is configured as a sub-array antenna in which two elements 11a-1 and 11a-2 are arranged in the arrangement direction of element antennas (x direction), and similarly, a second element antenna 11b is configured as a sub-array antenna in which two elements 11b-1 and 11b-2 are arranged in the arrangement direction of element antennas (x direction). Note that in FIG. 5, although only the first element antenna 11a and the second element antenna 11b are denoted by the symbols in order to avoid complexity of the drawing, other first element antennas 12a to 84a and other second element antennas 12b to 84b are also configured similarly.

Furthermore, also in the third embodiment, a circuit for supplying a high-frequency signal may be included in each of the first element antennas 11a to 84a and the second element antennas 11b to 84b like in the first embodiment. Alternatively, the multiple first element antennas 11a to 84a and the multiple second element antennas 11b to 84b may be each grouped, and a circuit for supplying a high-frequency signal may be included in each of the grouped units.

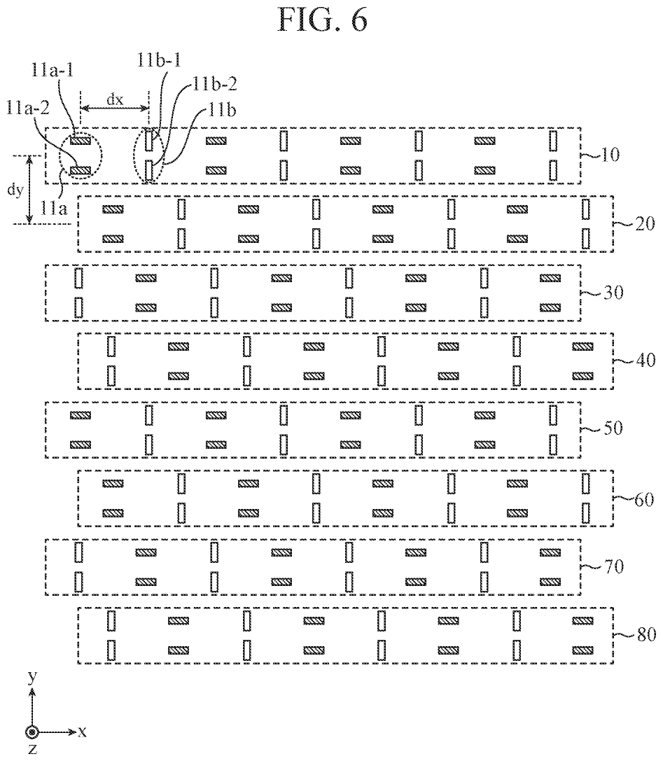

Furthermore, as illustrated in FIG. 6, a first element antenna 11a may include two elements 11a-1 and 11a-2 arranged in they direction, and a second element antenna 11b may include two elements 11b-1 and 11b-2 arranged in they direction. Other first element antennas 12a to 84a and other second element antennas 12b to 84b also have similar configurations.

Further alternatively, one element antenna includes two elements in the examples of FIGS. 5 and 6; however, three or more elements may be included. Moreover, as one element antenna, multiple elements may be arranged in each of the x direction and the y direction on a plane. Furthermore, although the polarization of two elements is the x-direction polarization or the y-direction polarization in the examples of FIGS. 5 and 6, the polarization of two elements may be polarization of +45 degrees or polarization of −45 degrees as a configuration corresponding to the array antenna device of the second embodiment.

As described above, according to the array antenna device of the third embodiment, each of the first element antennas and the second element antennas includes a sub-array antenna in which multiple elements are linearly arranged in the arrangement direction of the first element antennas and the second element antennas in the linear array antenna. Thus, grating lobes can be suppressed even in an array antenna device having two polarization types.

In addition, according to the array antenna device of the third embodiment, each of the first element antennas and the second element antennas includes a sub-array antenna in which multiple elements are linearly arranged in the arrangement direction of the linear array antennas. Thus, grating lobes can be suppressed even in an array antenna device having two polarization types.

In addition, according to the array antenna device of the third embodiment, each of the first element antennas and the second element antennas includes a sub-array antenna in which multiple elements are arranged on a plane. Thus, grating lobes can be suppressed even in an array antenna device having two polarization types.

Note that the present invention may include a flexible combination of the embodiments, a modification of any component of the embodiments, or an omission of any component in the embodiments within the scope of the present invention.

### INDUSTRIAL APPLICABILITY

As described above, an array antenna device according to the present invention relates to a configuration including linear array antennas in each of which a first element antenna and a second element antenna are alternately arranged linearly, the first and second element antennas having respective polarization planes perpendicular to each other, and the array antenna device is suitable for use as an array antenna device for radar or wireless communication.

### REFERENCE SIGNS LIST

11a to 84a: first element antenna, 11b to 84b: second element antenna, 10 to 80: linear array antenna, 11a-1, 11a-2, 11b-1, and 11b-2: element

1. An array antenna device comprising:
linear array antennas in each of which a first element antenna and a second element antenna are alternately arranged linearly, the first and second element antennas having respective polarization planes perpendicular to each other,
wherein the linear array antennas are arranged in a direction perpendicular to an arrangement direction of the first and second element antennas,
in adjacent two of the linear array antennas, respective first element antennas each of which is the first element antenna and respective second element antennas each of which is the second element antenna are arranged so that positions of the respective first element antennas in the arrangement direction are shifted from each other by a half an arrangement interval and positions of the respective second element antennas in the arrangement direction are shifted from each other by a half the arrangement interval, the arrangement interval being an interval between the first element antenna and the second element antenna, and
in two of the linear array antennas, the first element antenna of one of the two and the second element antenna of another one of the two are arranged at a same position, and the second element antenna of the one of the two and the first element antenna of the other one of the two are arranged at a same position, the two being located two linear array antennas away from each other.

2. The array antenna device according to claim 1, wherein arrangement intervals of the first element antenna and the second element antenna in each of the linear array antennas are equal.

3. The array antenna device according to claim 1, wherein arrangement intervals of the linear array antennas are equal.

4. The array antenna device according to claim 1, wherein polarization of the first element antenna is either one of vertical polarization and horizontal polarization, and polarization of the second element antenna is another one of the vertical polarization and the horizontal polarization.

5. The array antenna device according to claim 1, wherein polarization of the first element antenna is either one of polarization of +45 degrees and polarization of −45 degrees, and polarization of the second element antenna is another one of the polarization of +45 degrees and the polarization of −45 degrees.

6. The array antenna device according to claim 1, wherein each of the first element antenna and the second element antenna includes a sub-array antenna in which multiple elements are linearly arranged in the arrangement direction of the first element antenna and the second element antenna in a corresponding one of the linear array antennas.

7. The array antenna device according to claim 1, wherein each of the first element antenna and the second element antenna includes a sub-array antenna in which multiple elements are linearly arranged in an arrangement direction of the linear array antennas.

8. The array antenna device according to claim 1, wherein each of the first element antenna and the second element antenna includes a sub-array antenna in which multiple elements are arranged on a plane.

9. The array antenna device according to claim 2, wherein polarization of the first element antenna is either one of vertical polarization and horizontal polarization, and polarization of the second element antenna is another one of the vertical polarization and the horizontal polarization.

10. The array antenna device according to claim 2, wherein polarization of the first element antenna is either one of polarization of +45 degrees and polarization of −45 degrees, and polarization of the second element antenna is another one of the polarization of +45 degrees and the polarization of −45 degrees.

11. The array antenna device according to claim 2, wherein each of the first element antenna and the second element antenna includes a sub-array antenna in which multiple elements are linearly arranged in the arrangement direction of the first element antenna and the second element antenna in a corresponding one of the linear array antennas.

12. The array antenna device according to claim 2, wherein each of the first element antenna and the second element antenna includes a sub-array antenna in which multiple elements are linearly arranged in an arrangement direction of the linear array antennas.

13. The array antenna device according to claim 2, wherein each of the first element antenna and the second element antenna includes a sub-array antenna in which multiple elements are arranged on a plane.

14. The array antenna device according to claim 3, wherein polarization of the first element antenna is either one of vertical polarization and horizontal polarization, and polarization of the second element antenna is another one of the vertical polarization and the horizontal polarization.

15. The array antenna device according to claim 3, wherein polarization of the first element antenna is either one of polarization of +45 degrees and polarization of −45 degrees, and polarization of the second element antenna is another one of the polarization of +45 degrees and the polarization of −45 degrees.

16. The array antenna device according to claim 3, wherein each of the first element antenna and the second element antenna includes a sub-array antenna in which multiple elements are linearly arranged in the arrangement direction of the first element antenna and the second element antenna in a corresponding one of the linear array antennas.

17. The array antenna device according to claim 3, wherein each of the first element antenna and the second element antenna includes a sub-array antenna in which multiple elements are linearly arranged in an arrangement direction of the linear array antennas.

18. The array antenna device according to claim 3, wherein each of the first element antenna and the second element antenna includes a sub-array antenna in which multiple elements are arranged on a plane.
